(19) United States
(12) Patent Application Publication
(10) Pub. No.: US 2017/0220680 A1
(43) Pub. Date: Aug. 3, 2017

(54) SEARCH QUERY REFORMULATION USING A USER-SELECTED TERM

(71) Applicant: Scott Hamilton Shattuck, Westminister, CO (US)

(72) Inventor: Scott Hamilton Shattuck, Westminister, CO (US)

(73) Assignee: GOOGLE INC., Mountain View, CA (US)

(21) Appl. No.: 13/615,793

(22) Filed: Sep. 14, 2012

Related U.S. Application Data
(63) Continuation of application No. 12/710,012, filed on Feb. 22, 2010, now abandoned.

(51) Int. Cl. G06F 17/30

(52) U.S. Cl. CPC G06F 17/30864

(57) ABSTRACT

Methods, systems, and apparatus, including computer programs encoded on a computer storage medium, for processing voice commands. In one aspect, a method includes obtaining one or more search results that a search engine has identified as being responsive to a search query, receiving a term that the user has selected from the search results, receiving user input selecting promotion, demotion, or phrase search criteria for the term, and automatically reformulating the search query based on the term and the promotion, demotion, or phrase search criteria.

### CROSS-REFERENCE TO RELATED APPLICATIONS

This application is a continuation of U.S. patent application Ser. No. 12/710,012, filed Feb. 22, 2010. The contents of the prior application are hereby incorporated by reference in their entirety.

### BACKGROUND

This specification generally relates to search engines.

Search engines provide search results in response to users' queries. While search results often get users ‘into the ballpark’ of information they desire, it is not uncommon for users to have to reformulate their search queries to find the information they desire. This successive query reformulation process is manual, increasing the overall time that is required for a user to reach a desired web resource.

One way to attempt to reduce this amount of time is to work on improving initial search result sets, using what might be called the ‘perfect search engine’ hypothesis. Under this hypothesis, it is assumed that, with sufficient contextual information about the user, the perfect search engine should be able to accurately disambiguate the user's intent and locate a desired web resource based on the user's initial search query.

Practically speaking, however, to succeed under this hypothesis the intent of the user's search query would have to be disambiguated through the use of a large number of query terms and/or by extensive knowledge of the user. The average user, however, is unlikely to enter such highly disambiguated search queries, and is also unlikely to be comfortable with the level of history collection that would be necessary to render their intent as unambiguous. Additionally, the phrasing of search queries is likely to remain terse and simplistic, providing just enough information to obtain a broad search result set that requires iterative reformulation for final success.

### SUMMARY

According to one innovative aspect of the subject matter described in this specification, a search query is automatically reformulated using a term that a user identifies from the search results of the search query. For instance, using a cursor, the user may highlight a term that is found in a snippet of text associated with a particular search result, and may specify that search results that reference resources that include the highlighted term are to be promoted or demoted in a ranking of search results for a successive search query. The term is then used to automatically reformulate the search query, and new search results are obtained.

The automatic reformulation of a search query using a user-identified term eliminates the need for user to attempt cumbersome, manual query reformulations that require repeated user inputs. In doing so, the user avoids a manual, iterative reformulation process, where the user must switch to an advanced search mode, individually decide on disambiguation terms, and then manually add the disambiguation terms to their queries using possibly unfamiliar Boolean syntax and quoting rules. By contrast, the enhanced technique described by this specification leverages search engine result data to suggest terms, without requiring any personal information or user history. Accordingly, the user is presented with an intuitive, point-and-click interface to quickly and easily reformulate or retarget their successive search engine queries, reducing the overall time that it takes a user to locate usable search results.

In general, another innovative aspect of the subject matter described in this specification may be embodied in methods that include the actions of obtaining one or more search results that a search engine has identified as being responsive to an original search query, identifying a term that the user has selected from the search results, determining that the user has selected promotion, demotion, or phrase search criteria, and automatically reformulating the original search query based on the term and the promotion, demotion, or phrase search criteria. Other embodiments of this aspect include corresponding systems, apparatus, and computer programs, configured to perform the actions of the methods, encoded on computer storage devices.

These and other embodiments may each optionally include one or more of the following features. For instance, identifying a term that the user has selected may further include identifying a term that the user has highlighted with a cursor, identifying a term that the user has copied to a clipboard application, or, when the search results each include a snippet of text, identifying a term that the user has selected from one or more snippets of text; the actions may also include receiving a signal indicating an invocation of a control for initiating the automatic reformulation of the original search query and, responsive to receiving the signal, communicating code between the search engine and a client device, the code, when invoked by the client device, causing the client device to display a control associated with the promotion, demotion, or phrase search criteria; the promotion criteria may specify that resources referenced by search results for the automatically reformulated search query that include the term are to be promoted, or that the resources referenced by the search results for the reformulated search query are required to include the term; the demotion criteria may specify that resources referenced by search results for the automatically reformulated search query that include the term are to be demoted, or that the resources referenced by the search results for the reformulated search query are required to not include the term; the phrase search criteria may specify that resources referenced by search results for the automatically reformulated search query are required to include the term, as exactly worded, in an exact order, and/or without any change or alterations; the promotion or demotion of particular search results may occur by altering the weights or relevance scores associated with the resources, so that they appear more relevant or less relevant among the search results associated with the reformulated search query; determining that the user has selected the promotion, demotion, or phrase search criteria may include that the user has selected a menu option on a context menu, the menu option being associated with the promotion, demotion, or phrase search criteria; the actions may also include displaying, adjacent to the user-selected term, and in a context menu of a user interface of a client device, an exclude control to require that resources referenced by search results for the automatically reformulated search query do not include the term, a demote control to specify that the resources referenced by the search results for the automatically reformulated search query that include the term are to be demoted, a promote control to specify that the resources referenced by the search results for the automatically reformulated search query that include the term are to be promoted, a require control to require that the resources referenced by the search results for the automatically reformulated search query include the term, and a phrase search control to specify that the resources referenced by the search results for the automatically reformulated search query are required to include the term, as exactly worded, in an exact order, and without any change; automatically reformulating the original search query may further include automatically adding the term to the original search query, the term being subject to an inclusion, exclusion or phrase search operator, or determining that the term is used as a query term of the original search query, and adding an inclusion, exclusion or phrase search operator to the query term of the original search query; determining that the user has selected promotion, demotion, or phrase search criteria further may include determining that the user has selected a keyboard shortcut associated with the promotion, demotion, or phrase search criteria; the actions may also include communicating the automatically reformulated search query between a client device and the search engine, and obtaining one or more search results that the search engine has identified as being responsive to the automatically reformulated search query; automatically reformulating the original search query may further include automatically reformulating the original search query by a client device; the actions may also include communicating information identifying the original search query, the user-selected term and the user-selected promotion, demotion, or phrase search criteria between a client device and the search engine, where automatically reformulating the original search query may further include automatically reformulating the original search query by the search engine; the actions may also include identifying one or more query terms of the original search query, where automatically reformulating the original search query may further include automatically reformulating the original search query based on the term, the promotion, demotion or phrase search criteria, and the query terms of the original search query.

In general, another innovative aspect of the subject matter described in this specification may be embodied in methods that include the actions of obtaining one or more search results that a search engine has identified as being responsive to a search query, receiving a term that the user has selected from the search results, receiving user input selecting promotion, demotion, or phrase search criteria for the term, and automatically reformulating the search query based on the term and the promotion, demotion, or phrase search criteria, where the promotion criteria specifies that resources referenced by search results for the automatically reformulated search query that include the term are to be promoted, or that the resources referenced by the search results for the reformulated search query are required to include the term, where the demotion criteria specifies that the resources referenced by search results for the automatically reformulated search query that include the term are to be demoted, or that the resources referenced by the search results for the reformulated search query are required to not include the term, and where the phrase search criteria specifies that the resources referenced by search results for the automatically reformulated search query are required to include the term, as exactly worded, in an exact order, and without any change. Other embodiments of this aspect include corresponding systems, apparatus, and computer programs, configured to perform the actions of the methods, encoded on computer storage devices.

These and other embodiments may each optionally include one or more of the following features. For instance, automatically reformulating the search query may include reformulating the search query without requiring a further user input; receiving a term that the user has selected may include receiving a term that the user has highlighted with a cursor, or receiving a term that the user has copied to a clipboard application; the search results may each include a snippet of text, and receiving a term that the user has selected may include receiving a term that the user has selected from one or more snippets of text; the actions may further include receiving a signal indicating an invocation of a control for initiating the automatic reformulation of the search query; the actions may further include, in response to receiving the signal, communicating code between the search engine and a client device, the code, when invoked by the client device, causing the client device to display a control associated with the promotion, demotion, or phrase search criteria; receiving user input selecting promotion, demotion, or phrase search criteria may include receiving user input selecting a menu option on a context menu, the menu option being associated with the promotion, demotion, or phrase search criteria; the actions may further include displaying, adjacent to the user-selected term, and in a context menu of a user interface of a client device, an exclude control to require that the resources referenced by search results for the automatically reformulated search query do not include the term, a demote control to specify that the resources referenced by the search results for the automatically reformulated search query that include the term are to be demoted, a promote control to specify that the resources referenced by the search results for the automatically reformulated search query that include the term are to be promoted, a require control to require that the resources referenced by the search results for the automatically reformulated search query include the term, and a phrase search control to specify that the resources referenced by the search results for the automatically reformulated search query are required to include the term, as exactly worded, in an exact order, and without any change; automatically reformulating the search query may include automatically adding the term to the search query, subject to an inclusion, exclusion or phrase search operator; automatically reformulating the search query may include determining that the term is used as a query term of the search query, and adding an inclusion, exclusion or phrase search operator to the query term of the search query; receiving user input selecting promotion, demotion, or phrase search criteria may include receiving user input selecting a keyboard shortcut associated with the promotion, demotion, or phrase search criteria; the actions may further include communicating the automatically reformulated search query between a client device and the search engine, and obtaining one or more search results that the search engine has identified as being responsive to the automatically reformulated search query; automatically reformulating the search query may further include automatically reformulating the search query by a client device; the actions may include communicating information identifying the search query, the term and the user input between a client device and the search engine, and automatically reformulating the search query may further include automatically reformulating the search query by the search engine; the actions may further include receiving one or more query terms of the search query, and automatically reformulating the search query may further include automatically reformulating the search query based on the term, the promotion, demotion or phrase search criteria, and the query terms of the search query.

The details of one or more embodiments of the subject matter described in this specification are set forth in the accompanying drawings and the description below. Other potential features, aspects, and advantages of the subject matter will become apparent from the description, the drawings, and the claims.

### BRIEF DESCRIPTION OF THE DRAWINGS

FIG. 1 is a diagram demonstrating automatic search query reformulation using a user-selected term.

FIG. 2 is a diagram of an example system.

FIG. 3. is a flowchart of an example process.

FIGS. 4 and 5 depict example user interfaces.

Like reference numbers represent corresponding parts throughout.

### DETAILED DESCRIPTION

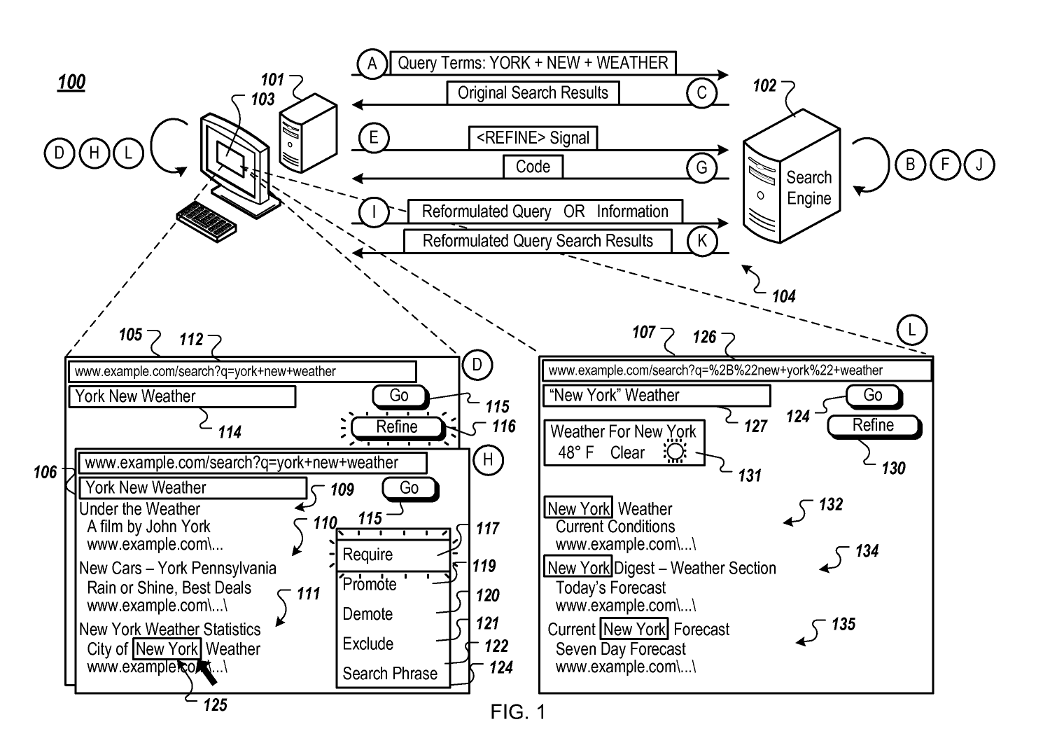

FIG. 1 is a diagram demonstrating the automatic reformulation of a search query using a user-selected term. Initially, as used by this specification, a “term” (or “query term”) includes one or more whole or partial words, characters, or strings of characters; “reformulation” of a search query involves rewriting, updating, changing, or revising an existing or previously-submitted query; and “automatic” refers to an operation that is performed by a machine or that does not require manual intervention or numerous user inputs.

Furthermore, as used by this specification, a “search query” includes the one or more query terms that the user submits to a search engine when the user requests the search engine to execute a search. Among other things, a “result” (or a “search result”) of the search includes a Uniform Resource Identifier (URI) that references a resource that the search engine determines to the be responsive to the search query. The search result may include other things, such as a title, preview image, user rating, map or directions, description of the corresponding resource, or a snippet of text that has been automatically or manually extracted from or otherwise associated with the corresponding resource.

As used by this specification, selecting a term from a search result may include highlighting, copying, or otherwise identifying a term from the title, description, snippet of text, or any other portion of one or more of the search results that are displayed on a search engine results page. In addition to selecting text, the user may select non-text content as well from the search engine results page. For example, the user may select an image, a region of an image, or even a single pixel (in the case of a color selection), to initiate a search that relates to the image content. Similarly, the selection of a portion of an audio track or similar rich media may also serve to initiate the reformulation of a search query.

The system 100 illustrated in FIG. 1 includes a client device 101 (e.g, a personal computer) and a search engine 102 (e.g., the Google search engine). FIG. 1 further illustrates both the flow of data 104 between the client device 101 and the search engine 102 during time-sequenced states “A” to “L,” as well as the user interfaces 105, 106 and 107 that are displayed on the display 103 of client device 101 during states “D,” “H” and “L,” respectively.

In the illustrated example, the user of the client device 101 is attempting to determine the current weather in New York, and does so by initiating a search dialogue on the client device 101 to locate a web page that includes information relating to this intended subject. The user enters the query terms “york,” “new,” and “weather,” in that order, into a search box that is displayed on the user interface of the client device 101. The search box may be included as a persistent user interface element of a web browser add-in or toolbar, or it may be included as a control on a search engine home page or a search engine results page.

The user selects a query control on the user interface to initiate the base, or “original,” search query. As used by this specification, the term “original” is merely intended to distinguish this search query from subsequent, or “successive,” search queries relative to the that search query, and is not intended to require this search query to be the first search query initiated by the user. For instance, the original search query may be a second or an Nth search query initiated by the user to locate an particular web page, where N can be any positive integer. Furthermore, the original search query may be a query that is automatically formulated, or that has already been automatically reformulated.

Responsive to the selection of the query control, and as shown in state “A,” the client device 101 transmits the original search query to the search engine 102 for execution. In state “B,” the search engine 102 executes a search on the original search query and identifies, in the search results of the original search query, resources that relate to the individual, user-entered query terms “york,” “new,” and “weather.” The resources that satisfy the original search query may be, for example, web pages that the search engine 102 has indexed during a previous crawl of a network.

The user may have entered the query terms “york,” “new,” and “weather,” under an incorrect assumption that the search engine 102 would not be able to identify any web pages other than those which are related to the current weather in New York. Alternatively, the user may have been aware that other web pages might exist but, operating under the “perfect search engine” hypothesis, might have expected that the search engine 102 would rank those web pages that relate to the current weather in New York highly among the search results. For instance, the user of the client device 101 might have assumed that the search engine 102 would use the user's search history or user profile information to promote websites relating to “weather” in “New York,” over web sites that were relevant to the separate query terms “weather,” “new” and “york,” but that were not specifically relevant to the current weather in New York. If the client device 101 has a small keyboard or other input mechanism that makes it difficult enter text, the user may have chosen to enter a query with fewer query terms, on the chance that any additional input might turn out to be superfluous.

In the illustrated example, the search engine 102 either does not have or does not utilize the user's search history or user profile information, and is unable to identify resources that are particularly relevant to the current weather in New York. In the alternative, the user's search history or user profile information may have been insufficient to properly disambiguate the intent of the original search query to highly rank resources that are relevant to the current weather in New York.

Because the user's ordering of the query terms of the original search query did not highlight the importance of the phrase “new york,” the search engine 102 identifies several web pages that relate to the individual query terms “york,” “new,” and “weather,” but that do not specifically relate to the current weather in New York. For instance, the search engine 102 has identified a first search result 109 that identifies a web page for new film called “Under the Weather,” by a man named John York; a second search result 110 that identifies a web page for a new car dealer in York, Pa., where the snippet associated with the web page uses weather-related words (“rain or shine”); and a third search result 111 that relates to a web page for past weather-related statistics for New York city.

In state “C”, the search engine 102 generates a file or resource that includes links to the search results associated with the original search query. The Uniform Resource Locator (“URL”) 112 of the file or resource is provided to the client device 101, which uses the URL 112 to locate and obtain the file. The file or resource includes code (e.g., HyperText Markup Language (HTML) code) that, when invoked by a layout engine on the client device 101, causes the client device 101 to display a search engine results page. Several items of information are encoded in the URL 112 itself, including the domain name of the search engine 102 (i.e., “www.example.com”), and the individual, ordered query terms “york,” “new,” and “weather.”

The query terms of the original search query are delimited from the remainder of the URL 112 by a token (“SEARCH?Q”) that is defined by the search engine. Other search engines may use other tokens to delimit query terms within a URL, or may use other techniques to associate query terms with a URL. For instance, the query parameters need not be encoded in the URL.

The user interface 105 displays the search engine results page, in state “D.” The user interface 105 includes an address box that displays the URL 112 associated with the original search query, and a search box 114 that displays the query terms associated with the original search query. The user interface also includes a re-query (“Go”) control 115 for initiating a successive search query using the query terms entered in the search box 114, and a “Refine” control 116 for initiating a process for automatically reformulating the original search query. The remainder of the user interface 105, which is partially obscured in FIG. 1, includes the search results 109, 110, and 111, and may include other information as well, such as additional search results and advertisements.

If the user is seeking to focus the search results of the original search query in order to determine the current weather in New York, the user may choose to reformulate the original search query to exclude any search results that do not specifically relate to this subject. To do so, the user could manually reformulate the original search query by typing additional query terms into the search box 114, by deleting or reordering existing query terms, or by applying inclusion or exclusion operators, and by selecting the re-query control 115 to initiate the execution of the manually reformulated search query. For instance, the desired query reformulation may occur by typing the new query terms “+′New York′ weather” or “york new weather−film−cars+current” into the search box 114, and initiating the execution of this query. Alternatively, the user could manually reformulate the original search query by adding the additional query terms to the URL 112, after the token, and initiating a request for a search engine results page associated with the manually reformulated URL.

Instead of performing a manual reformulation of the original search query, the user may select the refine control 116 to initiate a process for automatically reformulating the original search query. Upon selecting the refine control 116, a cursor change or message may notify the user that they should begin selecting a term on the page for addition to or exclusion from the original search query. When the user selects the refine control 116, in state “E,” a signal is transmitted from the client device 101 to the search engine 102, to indicate to the search engine 102 that the user intends to initiate the automatic reformulation of the original search query. The selection of the refine control 116 may also trigger other processes on the client device 101, such as a process that changes a context of an application or operating system invoked by the client device, or that displays controls on the client device 101 that are used for the automatic reformulation of the original search query.

The search engine 102 receives the signal and, in state “F,” generates code (e.g., JavaScript code) that, when invoked by the client device 101, will cause the client device 101 to display one or more controls associated with promotion, demotion, or phrase search criteria, and to accept a user-selection of a term and the promotion, demotion, or phrase search criteria. In state “G,” the search engine 102 transmits the code to the client device 101. If the code is already stored on the client device 101, for example in a web browser cache, the selection of the refine control 116 may cause the code to be loaded or invoked, instead of requesting that the code be sent from the search engine 102.

As discussed in further detail, however, in some implementations it is not necessary to signal the server. For example, the code to assist the user in performing the query reformulation may have been previously loaded by the client device 101, and server communication may not be required other than to submit the automatically reformulated query for execution. In another example, generating and supplying the code to the client device 101 may instead occur in conjunction with supplying the result of the original search query.

In state “H”, the client device obtains and invokes the code, and, in doing so, displays the controls associated with the promotion, demotion, or phrase search criteria. The user interface 106, which displays the search engine results page of user interface 105 in a later state, includes the controls 117 to 122 as menu options on context menu 124. The context menu 124 (also referred to as a “contextual menu,” a “shortcut menu,” or a “popup” or “pop-up menu”) is a menu in a user interface that appears upon user interaction, such as a right mouse click or middle click mouse operation. The context menu 124 offers a set of menu options that are available in connection with a selected object (i.e., a user-selected term) in the current state, or context, of an operating system or application. For example, the context menu 124 may appear in response to the user selection of the term 125.

Instead of using context menu 124, some other dialogue (e.g., implemented using a dynamic portion of HTML) may be used to display the menu. Such a dialogue may or may not be adjacent to the selected text, for example in the situation where a panel that slides down from the top of a window.

In some implementations, the available menu options identify actions that can be performed in relation to the selected term (i.e., one or more whole or partial words, characters, or strings of characters that are selected). The context menu 124 may be an augmented context menu that includes the controls as menu options in addition to menu options that are typically included in a default context menu, or the context menu 124 may be a replacement context menu that partially or completely replaces the default context menu. The controls 117 to 122 that are displayed in the context menu 124 include a “require” control 117, a “promote” control 119, a “demote” control 120, an “exclude” control 121, and a “search phrase” control 122. Other controls may also be displayed on the context menu 124.

When selected, the exclude control 121 operates to exclude search results that reference resources that include the user-selected term from the search results of a reformulated search query, and the require controls 117 operates to require search results that reference resources to include the user-selected term in the search results of a reformulated search query. Furthermore, when selected, the demote control 120 operates to demote (but not necessarily exclude) search results referencing resources that include the user-selected term in the search results of the reformulated search query, and the “promote” control 119 operates to promote (but not necessarily require) search results that reference resources that include the user-selected term in the search results of the reformulated search query.

Generally, the exclude control 121 and the demote control 120 allow the user to input demotion criteria for a particular user-selected term, while the require control 117 and promote control 119 allow the user to input promotion criteria for a particular user-selected term. The search engine 102 may promote or demote particular search results by altering the weights or relevance scores associated with the resources, so that they appear more relevant or less relevant among the search results associated with the reformulated search query. For example, assuming that two search results otherwise have a same search ranking or score, the search ranking or score of the promoted search result may be weighted or adjusted so that the promoted search result is ranked higher than the search result that is not promoted.

When selected, the “phrase search” control 122 operates to require the user-selected term, as exactly worded, in the exact word order as selected by the user, and/or without any change, in the search results of the reformulated search query. Notably, even though a phrase search and a more generic search may include phrases as query terms, the general search may substitute individual words of the phrase (e.g., with synonyms), may search the words of the phrase out of order, may add or remove suffixes or prefixes to the words of the phrase, or may make further alterations to the phrase.

A phrase search, on the other hand, may make no allowance for such alterations. In other words, a phrase search returns search results which exactly match the phrase selected by the user, while a more general search does not require the same fidelity to the original order and wording of an input phrase. While a general search may be useful, and may even be advantageous for novice users in some situations, it does not address the issue of using the selected term, as is, as an inclusive or exclusive qualifier to an original search query. In addition to performing a normal phrase search, menu options may also allow for the exact match concept to be applied to promotion, demotion, exclusion, or inclusion.

In other example user interfaces, different controls could be added or substituted, or certain ones of the illustrated controls could be omitted. For example, an “open” control may be added, where the open control includes a text entry field to allow a user to type in a term to be excluded, demoted, promoted, or required. A “next to” may be added, which allows for a subsequent selection of another term that must be next to a term that was previously selected. Additionally, a “suggest substitute” control can be added, which provides one or more suggestions for substitution of a selected term.

The controls 117 to 122 may be implemented by the code that is received from the search engine 102 (i.e., in state “G”). For instance, the selection of the refine control 116 may cause the dynamic loading of a JavaScript file or resource whose code, upon loading and execution by the client device 101, augments and/or replaces the search engine result page's context menu, which is typically accessed via by a click on the right-mouse button. In an alternative implementation, the controls 117 to 122 may be generated by the client device 101 without the involvement of the search engine 102, for example using code that is pre-programmed in a web browser add-in or toolbar, or code that is stored in a web browser cache or other memory.

Instead of the control types depicted in FIG. 1, the controls 117 to 122 may be check-boxes, slider bars, other types of buttons, or hyperlinks, such as links included in a tag cloud. As referred to by this specification, a “tag cloud” is a visual depiction of tags, or hyperlinks, that are used to link to the content of web sites. Tags may be single words and may be typically listed alphabetically, and the importance of a tag may be shown with font size or color.

The user selects the term 125 (“New York”) from the search result 111, and ‘right-clicks’ a computer mouse (or enters a predefined keyboard shortcut) to cause the context menu 124 to appear. No further user inputs are required to effect the automatic reformulation of the original search query.

When the require control 117 is selected off of the context menu 124, program code or logic attached to or otherwise associated with the require control 117 causes the client device 101 to automatically reformulate the original search query using the user-selected term 125, and to communicate the automatically reformulated search query to the search engine 102 for execution. Alternatively, selection of the require control 117 causes the client device 101 to communicate information to the search engine 102 to allow the search engine 102 to automatically reformulate the original search query using the user-selected term 125, and to initiate the execution of the automatically reformulated search query. The reformulated search query is automatically generated by the client device 101 or the search engine 102, based at least on the user-selected term and the promotion, demotion, or phrase search criteria.

Regardless of whether the original search query is automatically reformulated by the client device 101 or the search engine 102, three items of information are obtained in order to effect the automatic reformulation: the URL or query terms of the original search query, the user-selected text, and the user-selected promotion, demotion, or phrase search criteria. The query terms are obtained using a function invocation or property access, such as a JavaScript WINDOW.LOCATION property, that obtains the current URL of the search engine results page (i.e., user interfaces 105 or 106). When the current URL is obtained, the portion of the URL that refers to the query terms is parsed from the URL. In the present example, because the search engine 102 delimits the query terms from the remainder of the URL 112 using the token “SEARCH?Q”, the query terms are obtained by selecting the portion of the URL that follows this token.

In a similar manner, the user-selected text is obtained using a function invocation or property access that reads out highlighted text, such as a JavaScript WINDOW. GETSELECTION function. The promotion, demotion, or phrase search criteria may identified in the program code or logic that is associated with the selection of the associated control. For instance, code may be attached to a particular control such that, when a particular event occurs, causes the query terms and the user-selected term to be identified, and causes the original search query to be reformulated in accordance with the promotion, demotion, or phrase search criteria associated with the control, using the query terms of the original search query and the user-selected term. Alternatively, the selection of a particular control may cause a flag value to change such that, when the re-query “Go” control 115 is selected, program code associated with the re-query control can identify the particular control that was selected based on the value of the flag.

As shown in state “I,” the re-query control 115 operates to initiate the automatic reformulation of the original search query (if it has not already been automatically reformulated), and/or to initiate the execution of the reformulated query by the search engine 102. In the situation where the client device 101 generates the reformulated search query, the client device transmits the automatically reformulated search query (e.g. by sending a request using the URL “http://www.example.com/search?q%2B%22new york%22+weather}”) to the search engine 102. In the alternate situation where the search engine 102 generates the reformulated search query, the client device 101 transmits information identifying the query terms of the original search query (e.g., “search?q=york+new+weather”), and information identifying both the user-selected term and the promotion, demotion, or phrase search criteria associated with the user-selected term (e.g., +“new york” or %2B %22new york %22).

The client device 101 or the search engine 102 uses the user-selected term(s) 125 to automatically reformulate the original search query by adding the identified term(s) to the original search query, subject to an inclusion or exclusion operator (e.g., “+” or a “−” character, quotation marks, or a token such as “%2B”) selected for the respective term(s). Alternatively, when the client device 101 or the search engine 102 determines that the user-selected term already exists as a query term of the original search query, the client device 101 or the search engine 102 may automatically reformulate the original search query by adding the inclusion or exclusion operator to the query term, and/or by reordering the query terms. In addition to or instead of inclusion or exclusion operators, other query reformulation approaches are also possible, such as by adding Boolean operators to the original search query. When different search engines use different inclusion or exclusion operators to promote or demote certain terms, those operators are substituted for the “+” and “−” characters.

In response to executing the reformulated search query, in state “J,” the search engine 102 generates search results for the reformulated search query. In state “K,” the search engine 102 generates a file or resource that includes links to search results associated with the original search query, and the client device 101 obtains the file or resource. In state “L,” the file or resource is invoked by a layout engine on the client device, causing the client device to display a search engine results page in the user interface 107.

The user interface 107 displays the URL 126 associated with the reformulated search query in an address box. Contrasted with the URL 112 for the search results page associated with the original search query, which identifies the query terms as “york+new+weather,” the URL 126 for the search results page associated with the reformulated search query identifies the query terms as “%2B %22new york %22+weather.” In URL 126, the token “%2B” serves as an inclusion operator, and the token “%22” serves as a quotation operator. Notably, the reordering of the query terms and the application of an inclusion operator and quotation operator around the term “new york” were performed automatically, and reflect the term and the promotion criteria that were selected by the user through the user interface 106.

The user interface 107 also includes a search box 127 that displays the query terms associated with the reformulated search query, a re-query control 129 for initiating a successive search query using the query terms entered in the search box 127, and a refine control 130 for initiating a process for automatically reformulating the reformulated search query. The user interface 107 also includes an answer box 131 that answers the reformulated search query using information known to the search engine 102, and search results 132 to 135 that the search engine 102 has identified as being relevant to the reformulated search query. Notably, the search results 132 to 135 each include the user-selected term 125, and are more relevant of the subject of the current weather in New York than were the search results 109 to 111.

The process of reformulating the search query may end in state “J,” or the process may iteratively continue (e.g., back to state “D”) if the user selects a refine control, or selects a term from the search results 132 to 135 and other promotion, demotion, or phrase search criteria, and initiates the automatic reformulation of this automatically reformulated search query.

By basing the automatic reformulation of the original search query on the content of the search results that the search engine has identified in response to an original search query, the enhanced search query reformulation approach illustrated in FIG. 1 closely models, but improves upon, the approach that users manually perform. For instance, when faced with search results that reference resources that do not satisfy the user's need for information, a user may scan the text of a few pages of search results for terms are most prevalent, and attempt to manually add those terms and unfamiliar inclusion or exclusion operators to the original search query. By automating this process using an intuitive user interface, search query reformulation can be done efficiently and effectively, creating an opportunity to have the most impact on improving subsequent query results and the overall user experience in terms of the time required to locate useable results.

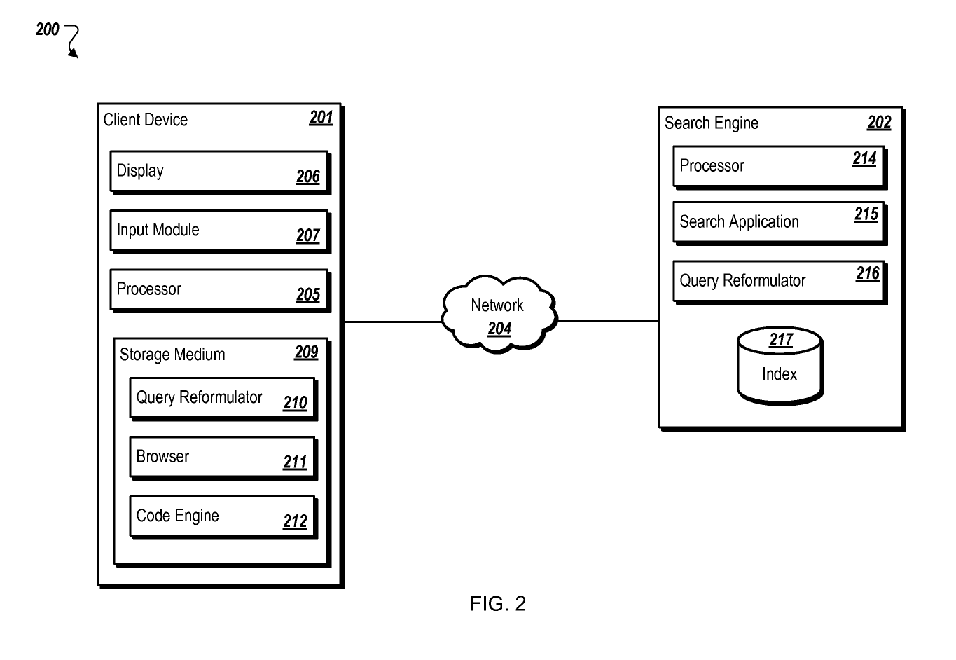

FIG. 2 is a block diagram of an example system 200 that includes a client device 201 and a search engine 202 that are connected by way of a network 204. The network may be any public or private computer network, such as the Internet or a corporate intranet. The client device 201, which may perform some or all of the functionalities associated with client device 101, may be any type of computing device or system that includes one or more processors 205, including a server, a laptop or desktop computer, a mobile telephone, a personal digital assistant (PDA), a tablet computer, or an embedded system. The client device 201 includes a display 206 for outputting the text and/or graphics that make up the various user interfaces used for performing searches and automated search query reformulations, and an input module 207 (e.g., a touch screen, a mouse, a microphone, or a keyboard) for receiving user inputs. Among the many items and applications that may be stored on the storage medium or apparatus 209, the client device 201 stores a query reformulator 210 for automatically reformulating search queries, a web browser 211, and one or more code engines 212 (e.g., a layout engine and/or a JavaScript engine).

The search engine 202, which may perform some or all of the functionalities associated with the search engine 102, may also be any type of computing device or system that includes one or more processors 214. In one example, the search engine 202 is the Google search engine. In addition to the processors 214, the search engine 202 includes a search application 215 that, among other things, invokes part or all of the search functionality described by this specification. The search engine 202 also includes a query reformulator 216 that, in addition to or instead of query reformulator 210, automatically reformulates search queries, and an index 217 of the resources that have been visited or crawled by the search engine 202.

In some example implementations, the functionalities illustrated in association with the client device 201, and the search engine 202 may actually be performed by different components of the system 200. For instance, the client device 201 may maintain part or all of the index 217. In other example implementations, the functionality of the client device 201 and the search engine 202 are performed by a single device.

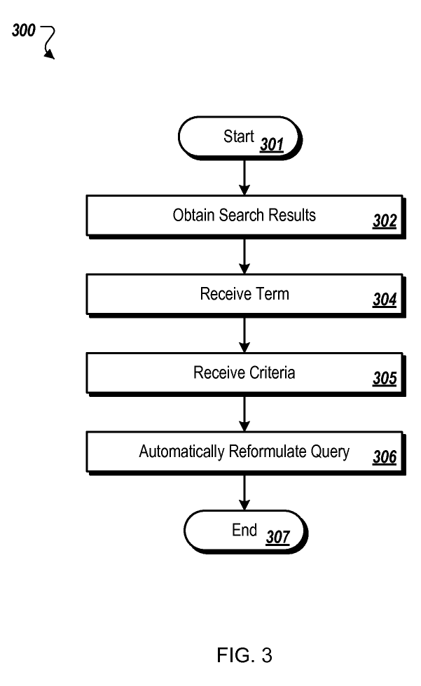

FIG. 3 is a flowchart of an example process 300 for performing search query reformulation using a user-selected term. Briefly, the process 300 includes the actions of obtaining one or more search results that a search engine has identified as being responsive to a search query, receiving a term that the user has selected from the search results, receiving user input selecting promotion, demotion, or phrase search criteria for the term, and automatically reformulating the search query based on the term and the promotion, demotion, or phrase search criteria.

In more detail, when the process 300 begins (301), one or more search results are obtained (302). The search results may be results that a search engine has identified as being responsive to an original search query. For instance, a user may initiate the execution of an original search query by invoking a search dialogue (e.g., visiting “www.google.com,” or invoking a persistent toolbar with a search box) on a client device, entering query terms into a search box, and selecting a control to instruct a search engine to execute the original search query. A search application on the client device or search engine identifies resources that satisfy the original search query, and provides links to the identified resources as part of the search results of the original search query. The identified resources may include resources that the search engine has previously crawled and indexed.

The user may select a refine control (e.g., a JavaScript element, a checkbox, a button, a voice prompt, a hyperlink, or any other visual or non-visual element) to initiate the automatic reformulation of the original search query, or to display other controls that allow the user to select promotion, demotion, or phrase search criteria. The refine control may be displayed adjacent to a search box on a search engine home page or a search engine results page.

When the refine control is selected, the client device may send a signal to the search engine. The signal may indicate that the user intends to initiate the automatic reformulation of the original search query, or that the automatic reformulation of the original search query has occurred. In response to receiving the signal, the search engine may send code to the client device for implementing controls that are associated with the promotion, demotion, or phrase search criteria. A cursor change or message may notify the user that they should begin selecting a term on the page for addition or exclusion from the original search query. Alternatively, if the code is already stored on the client device, the cursor change or message is generated in response to execution of the code.

In some implementations, the automatic reformulation of the original search query may occur without requiring the user to select specific refine control, for example where the search engine adds the code for implementing the automatic reformulation of an original search query in all search engine result pages. Furthermore, the user may set preferences that identify the circumstances when query reformulation should be provided without receiving a user selection of a refine control, and when it should not be provided until a refine control is selected.

Although fewer user inputs or selections are required when a refine control is not used, the inclusion of code in many or all search engine result pages has the potential to significantly increase the load on the search engine. This increase in load could be mitigated, for example, by caching the code or other supporting files in a web browser cache.

In the situation where code for implementing the automatic reformulation of the original search query is included in all search engine result pages, the refine control may still be present, and selection of the control may trigger the replacement or augmentation of the standard context menu associated with the search engine results page. For instance, the context menu associated with the search engine results page may remain in a default state until the refine control is selected. However, the code elements (e.g., JavaScript code) needed to trigger the replacement or augmentation of the default context menu would have been included with the search engine results page, so that additional code does not need to be dynamically loaded when the refine control is selected.

Instead of using a context menu, some other dialogue (e.g., implemented using a dynamic portion of HTML) may be used to display the menu. Such a dialogue may or may not be adjacent to the selected text, for example in the situation where a panel that slides down from the top of a window

The user selects a term from the search results (304), and the term is received or obtained by the client device or search engine. The user-selected term is used to reformulate a successive search query, based on user-specified promotion or demotion criteria. The user may select a term by highlighting a term from a snippet of text associated with a search result, with a cursor, or by copying a term to a clipboard application. The client device may identify the user-selected term using a function, such as a JavaScript WINDOW.GETSELECTION function.

In addition to selecting text, the user may select non-text content as well from the search engine results page. For example, the user may select an image, a region of an image, or even a single pixel (in the case of a color selection), to initiate a search that relates to the image content. Similarly, the selection of a portion of an audio track or similar rich media may also serve to initiate the reformulation of a search query.

The client device may display one or more controls (e.g., checkboxes, buttons, voice prompts, hyperlinks, text entry fields, or any other visual or non-visual elements) that are associated with promotion, demotion, or phrase search criteria. The controls, which may be context menu options, may be displayed adjacent to the user-selected term. The controls may include an exclude control to require that resources referenced by search results for the automatically reformulated search query do not include the term, a demote control to specify that the resources referenced by the search results for the automatically reformulated search query that include the term are to be demoted, a promote control to specify that the resources referenced by the search results for the automatically reformulated search query that include the term are to be promoted, a require control to require that the resources referenced by the search results for the automatically reformulated search query include the term, and a phrase search control to specify that the resources referenced by the search results for the automatically reformulated search query are required to include the term, as exactly worded, in an exact order, and without any change.

The controls associated with promotion, demotion or phrase search criteria may be integrated directly into the default context menu of the web browser. By modifying the web browser's executable files or the various plug-ins or add-ons (e.g., a Chrome or Firefox plug-in) associated with the web browser, a third party vendor could add the automatic query reformulation feature directly to an otherwise standard context menu. The controls may be added to the context menu only for those web pages that are determined to be search engine results pages, for example where the domain name associated with the web page is a known search engine.

The user selects promotion, demotion, or phrase search criteria (305), for example by providing a user input selecting a menu option on a context menu, or a keyboard shortcut. Information identifying the original search query (e.g., as determined using a JavaScript WINDOW.LOCATION property), the user-selected term and the user-selected promotion, demotion, or phrase search criteria is determined for use in automatically reformulating the original search query.

The original search query is automatically reformulated, by the client device or the search engine, based on the term, the promotion, demotion, or phrase search criteria, and/or the query terms of the original search query (306). Automatically reformulating the original search query may further include automatically adding the term to the original search query, subject to an inclusion, exclusion, phrase search, or other operator, as defined by the search engine. When the term is already used as a query term of the original search query, automatically reformulating the original search query may include reordering the query term in the original search query, or adding an inclusion, exclusion or phrase search operator to the query term of the original search query.

The automatically reformulated search query may be communicated between the client device and the search engine. Automatically reformulated search queries can be buffered and communicated to the search engine in a batch of search queries. The search engine may use the one or more automatically reformulated search queries to identify search results that are responsive to the automatically reformulated search query, thereby ending the process 300 (307).

While process 300 describes the various obtaining, identification, selection and automatic reformulation operations as occurring in a particular order or by particular devices and systems, they may occur in other orders as well, and certain operations may be entirely omitted or may occur, either in whole or part, on different devices and systems.

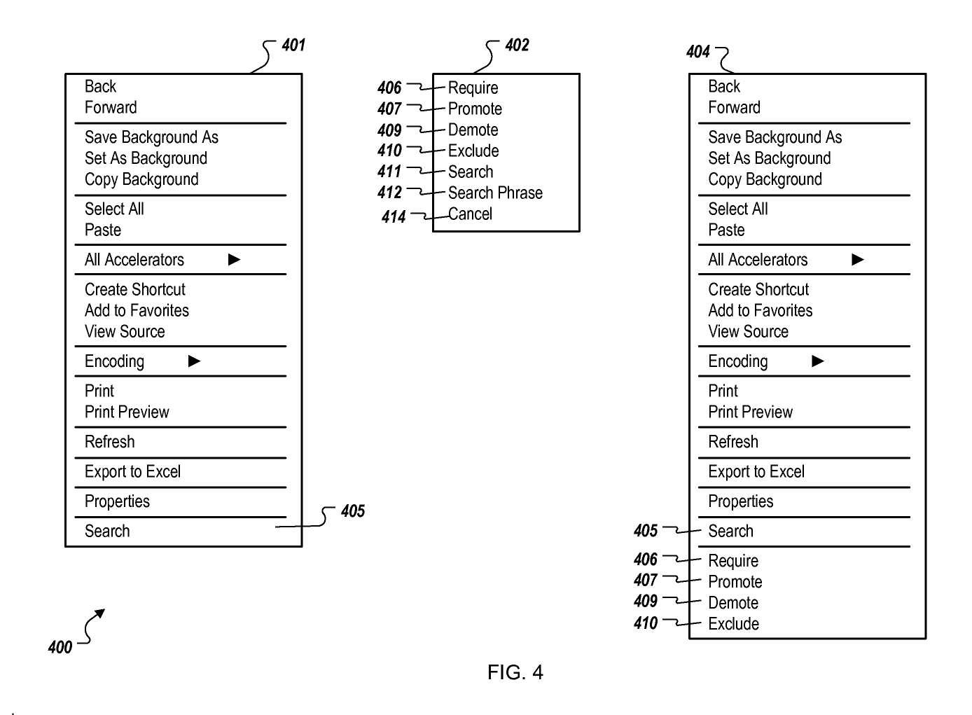

FIG. 4 depicts example context menus 401 to 404 that may be used to implement the automatic reformulation of an original search query. The context menu 401 is displayed before the user initiates the automatic reformulation of the original search query (i.e., before selecting a refine control), and context menus 402 and 404 are displayed after the user initiates the automatic reformulation of the original search query. For instance, the context menus 402 and 404 may be displayed in a web browser when the user selects a term from a search result.

The automatic reformulation of an original search query may be initiated by a user selection of a refine control. In such circumstances, and as illustrated by context menu 401, the set of menu options that are available in connection with the a user-selected term before the initiation of the automatic reformulation may include functions such as “Print,” “Properties,” and “Select All.” Although the context menu 401 includes a “Search” menu option 405, the selection of this option may result in a general search and not a phrase search. Notably, the context menu 401 does not include menu options or other controls that are associated with promotion, demotion, or phrase search criteria.

Context menu 402 illustrates an example of where a default context menu (e.g., context menu 401) is replaced by a context menu that is tailored to automatic query reformulations, after the initiation of the automatic reformulation of an original search query. Specifically, and instead of more general menu options such as the “Print,” “Properties,” and “Select All” functions, the context menu 402 includes a require menu option 406, a promote menu option 407, a demote menu option 409, an exclude menu option 410, associated with require, promote, demote and exclude criteria, respectively. The context menu 402 also includes a search menu option 411 associated with a general, ‘non-phrase search’ search, and a “search phrase” menu option 412 associated with phrase search criteria.

A cancel menu option 414 allows the user to cancel the automatic query reformulation dialogue, returning the context menu 402 to a state that is not specifically tailored to automatic query reformulations. For example, the selection of the cancel menu option 414 may cause the context menu 402 to be replaced with the context menu 401.

Context menu 404 illustrates an example where a default context menu is augmented by menu options that are tailored to automatic query reformulations, after the initiation of the automatic reformulation of an original search query, or, alternatively, if the automatic reformulation functionality is provided as a browser plug-in. The set of menu options that are available in connection with the a user-selected term after the initiation include the same general menu options that were available before the initiation of the automatic query reformulation, such as the “Print,” “Properties,” and “Select All” functions. In addition, however, the context menu 404 includes additional menu options that are tailored to automatic query reformulations. Specifically, the context menu 404 includes a require menu option 406, a promote menu option 407, a demote menu option 409, and an exclude menu option 410.

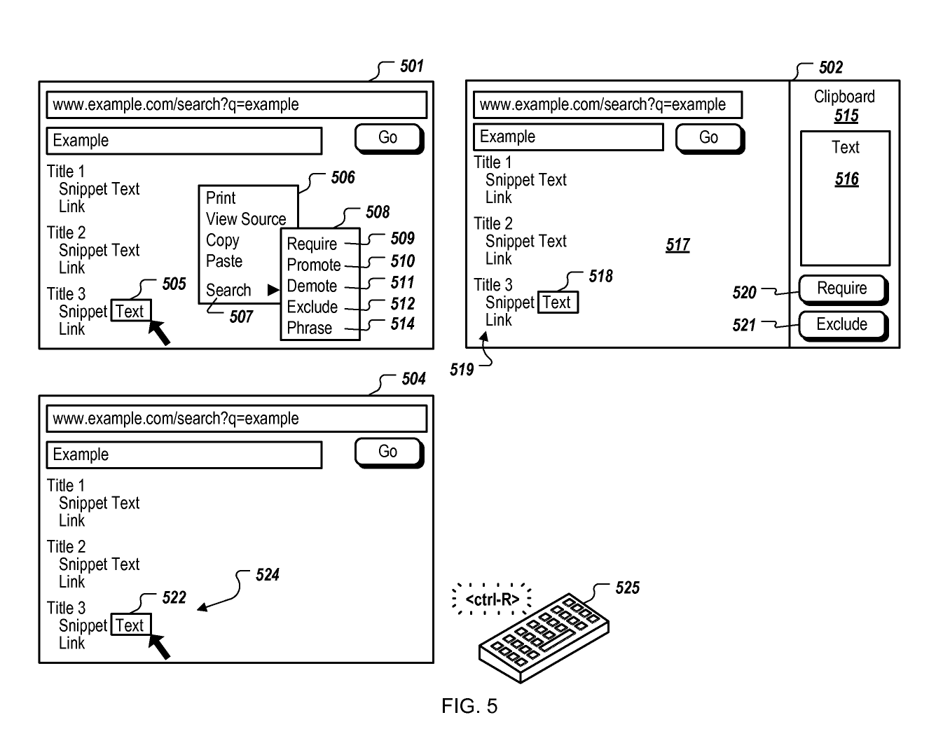

FIG. 5 illustrates example user interfaces 501 to 504, in which the user-selection of promotion, demotion, or phrase search criteria occur through different approaches than are described above. Specifically, in user interface 501, once term 505 has been selected by the user, a first context menu 506 is displayed in response to a first user interaction (i.e., a right-click of a mouse). Among the several menu options included on the first context menu 506 is a “search” menu option 507 that, in response to a second user interaction (i.e., a mouse-over event occurring over the menu option 507), opens a nested, second context menu 508. The second context menu 508 includes a require menu option 509, a promote menu option 510, a demote menu option 511, an exclude menu option 511, and a phrase search menu option 514. Selection of any of the menu options in the second context menu 508 results in the automatic reformulation of a search query based on the promotion, demotion, or phrase search criteria associated with the selected menu option.

In the user interface 502, functionality that provides for the automatic reformulation of the original search query is integrated into a clipboard application that is executing on the client device. The clipboard application 515 is a software facility that is used for short-term data storage and/or data transfer between documents or applications, via copy and paste operations. The clipboard application 515 is a part of the graphical user interface environment of the client device, and is implemented as an temporary block of memory that can be accessed from most or all programs within the environment via defined programming interfaces. An application executing on the client device accesses clipboard functionality by mapping a user input to these defined programming interface.

The clipboard application 515 includes a region 516 that displays terms that are copied to the clipboard application 515 from a search engine results page (specifically, user-selected term 518 (“text”) from search result 519). The clipboard application 515 also includes controls 520 and 521, associated with promotion and demotion criteria, respectively. When the user copies the term 518 into the clipboard application 515 and selects one of the controls 520 and 520, the original search query is automatically reformulated based on the term 518 and the promotion or demotion criteria associated with the selected control.

The user interface 504 illustrates an example where the selection of the promotion, demotion or phrase search criteria occurs without requiring the user to select a graphical control or menu option. Specifically, after the user has selected the term 522 (“text”) from the search result 522, the user types a predefined keyboard shortcut (e.g., “<ctrl>-r”) associated with promotion, demotion, or phrase search criteria, using keyboard 525. Upon detecting the keyboard shortcut, the client device identifies (e.g., using a look-up table) the specific promotion, demotion, or phrase search criteria associated with that keyboard shortcut. The client device either uses the identified criteria to automatically reformulate the original search query, or provides information identifying the identified criteria, among other things, to a search engine so that the original search query may be automatically reformulated.

A number of implementations have been described. Nevertheless, it will be understood that various modifications may be made without departing from the spirit and scope of the disclosure. For example, various forms of the flows shown above may be used, with steps re-ordered, added, or removed. Accordingly, other implementations are within the scope of the following claims.

Embodiments of the invention and all of the functional operations described in this specification can be implemented in digital electronic circuitry, or in computer software, firmware, or hardware, including the structures disclosed in this specification and their structural equivalents, or in combinations of one or more of them. Embodiments of the invention can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as a program, software, software application, script, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a tablet computer, a mobile telephone, a personal digital assistant (PDA), a mobile audio player, a Global Positioning System (GPS) receiver, to name just a few. Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the invention can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the invention, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

In each instance where an HTML file is mentioned, other file types or formats may be substituted. For instance, an HTML file may be replaced by an XML, JSON, plain text, or other types of files. Moreover, where a table or hash table is mentioned, other data structures (such as spreadsheets, relational databases, or structured files) may be used.

Thus, particular embodiments of the invention have been described. Other embodiments are within the scope of the following claims. For example, the actions recited in the claims can be performed in a different order and still achieve desirable results.

What is claimed is:

1.-20. (canceled)

21. A computer-implemented method, comprising:
receiving, from a search engine, a search results page that includes
(i) search results that are responsive to a search query, each search result including at least (a) a link to a resource that the search engine has identified as responsive to the search query, (b) a title or description of the resource, and (c) a snippet of text, wherein the snippet of text includes a string of contiguous words that are automatically extracted from the resource, and wherein the snippet of text includes one or more of the query terms among the contiguous words, and
(ii) a control for initiating a search query refinement,
wherein the search results page is associated with a context menu having a first plurality of controls;
in response to receiving data indicating a user selection of the control for initiating a search query refinement, executing code that modifies the context menu associated with the search results page by adding search query revision controls that are not included in the first plurality of controls, the modified context menu permitting the user to refine the search query based on any of the words in the string of contiguous words in one or more of the snippets of text;
identifying (i) a term that the user has selected within the string of contiguous words in the snippet of text of one of the search results and (ii) a control selected from the modified context menu by the user, wherein the control selected from the modified context menu indicates how the search query is to be revised;
revising the search query based on (i) the identified term that the user has selected within the string of contiguous words in the snippet of text of one of the search results and (ii) the control selected from the modified context menu;
providing the revised search query to the search engine; and
receiving, from the search engine, second search results identified in response to the revised search query.

22. The method of claim 21, wherein the modified context menu is a menu accessible by a click on a right-mouse button.

23. The method of claim 21, comprising displaying data indicating the revised search query.

24. The method of claim 21, wherein the code that modifies the context menu further provides a modified cursor that is different from a cursor provided before executing the code.

25. The method of claim 21, wherein the control selected from the modified context menu by the user comprises:
exclude data to require that the resources referenced by search results for the revised search query do not include the term;
demote data to specify that the resources referenced by the search results for the revised search query that include the term are to be demoted;
promote data to specify that the resources referenced by the search results for the revised search query that include the term are to be promoted;
require data to require that the resources referenced by the search results for the revised search query include the term; or
phrase search data to specify that the resources referenced by the search results for the revised search query are required to include the term, as exactly worded, in an exact order, and without any change.

26. (canceled)

27. The method of claim 21, wherein executing the code that modifies the context menu comprises removing, from the context menu, one or more controls from the first plurality of controls.

28. (canceled)

29. The method of claim 21, wherein the code is stored on one or more computing devices before receiving data indicating a user selection of the control, and is dynamically retrieved from the one or more computing devices in response to receiving the data indicating a user selection of the control.

30. A system comprising:
one or more computers and one or more storage devices storing instructions that are operable, when executed by the one or more computers, to cause the one or more computers to perform operations comprising:
receiving, from a search engine, a search results page that includes
(i) search results that are responsive to a search query, each search result including at least (a) a link to a resource that the search engine has identified as responsive to the search query, (b) a title or description of the resource, and (c) a snippet of text, wherein the snippet of text includes a string of contiguous words that are automatically extracted from the resource, and wherein the snippet of text includes one or more of the query terms among the contiguous words, and
(ii) a control for initiating a search query refinement,
wherein the search results page is associated with a context menu having a plurality of controls;
in response to receiving data indicating a user selection of the control for initiating a search query refinement, executing code that modifies the context menu associated with the search results page by adding search query revision controls that are not included in the first plurality of controls, the modified context menu permitting the user to refine the search query based on any of the words in the string of contiguous words in one or more of the snippets of text;
identifying (i) a term that the user has selected within the string of contiguous words in the snippet of text of one of the search results and (ii) a control selected from the modified context menu by the user, wherein the control selected from the modified context menu indicates how the search query is to be revised;
revising the search query based on (i) the identified term that the user has selected within the string of contiguous words in the snippet of text of one of the search results and (ii) the control selected from the modified context menu;
providing the revised search query to the search engine; and
receiving, from the search engine, second search results identified in response to the revised search query.

31-33. (canceled)

34. The system of claim 30, wherein the control selected from the modified context menu by the user comprises:
exclude data to require that the resources referenced by search results for the revised search query do not include the term;
demote data to specify that the resources referenced by the search results for the revised search query that include the term are to be demoted;
promote data to specify that the resources referenced by the search results for the revised search query that include the term are to be promoted;
require data to require that the resources referenced by the search results for the revised search query include the term; or
phrase search data to specify that the resources referenced by the search results for the revised search query are required to include the term, as exactly worded, in an exact order, and without any change.

35-37. (canceled)

38. The system of claim 30, wherein the code is stored on one or more computing devices before receiving data indicating a user selection of the control, and is dynamically retrieved from the one or more computing devices in response to receiving the data indicating a user selection of the control.

39. A non-transitory computer-readable medium storing software comprising instructions executable by one or more computers which, upon such execution, cause the one or more computers to perform operations comprising:
receiving, from a search engine, a search results page that includes
(i) search results that are responsive to a search query, each search result including at least (a) a link to a resource that the search engine has identified as responsive to the search query, (b) a title or description of the resource, and (c) a snippet of text, wherein the snippet of text includes a string of contiguous words that are automatically extracted from the resource, and wherein the snippet of text includes one or more of the query terms among the contiguous words, and
(ii) a control for initiating a search query refinement,
wherein the search results page is associated with a context menu having a first plurality of controls;
in response to receiving data indicating a user selection of the control for initiating a search query refinement, executing code that modifies the context menu associated with the search results page by adding search query revision controls that are not included in the first plurality of controls, the modified context menu permitting the user to refine the search query based on any of the words in the string of contiguous words in one or more of the snippets of text;
identifying (i) a term that the user has selected within the string of contiguous words in the snippet of text of one of the search results and (ii) a control selected from the modified context menu by the user, wherein the control selected from the modified context menu indicates how the search query is to be revised;
revising the search query based on (i) the identified term that the user has selected within the string of contiguous words in the snippet of text of one of the search results and (ii) the control selected from the modified context menu;
providing the revised search query to the search engine; and
receiving, from the search engine, second search results identified in response to the revised search query.

40-41. (canceled)

42. The method of claim 21, wherein receiving the search results page comprises receiving a search results page comprising the code that provides the modified context menu,
the code being configured to provide the modified context menu having multiple options for reformulating the search query based on any user-identified term within the string of contiguous words of one of the search results.

43. The method of claim 21, wherein the method comprises:
receiving data indicating a user selection of the control for initiating a search query refinement;
in response to receiving data indicating the user selection of the control for initiating a search query refinement, providing, to the search engine, data indicating the user selection of the control; and
receiving, from the search engine and after providing data indicating the user selection of the control for initiating a search query refinement, the code that provides the modified context menu;
wherein executing the code that provides the modified context menu comprises executing the code that was received after providing data indicating the user selection of the control for initiating a search query refinement.

44. The method of claim 21, wherein executing the code that modifies the context menu comprises executing code that provides a modified context menu that permits the user to refine the search query based on any of the words in the title or description of the resource corresponding to one or more of the search results.

45. The method of claim 21, wherein the method comprises receiving data indicating a user interaction with the string of contiguous words included in one of the snippets of text, the data indicating that a user interacted with a portion of the string of contiguous words that includes a particular term;
wherein identifying the term that the user has selected within the string of contiguous words in the snippet of text in one of the search results comprises identifying the particular term in the portion of the string of contiguous words that the user interacted with; and
wherein revising the search query based on the identified term comprises revising the search query based on the particular term in the portion of the string of contiguous words that the user interacted with.

46. The method of claim 21, wherein the method comprises receiving data indicating a user interaction with the string of contiguous words included in one of the snippets of text, the user interaction causing a particular term within the string of contiguous words of the snippet to be highlighted on a user interface;
wherein identifying the term that the user has selected within the string of contiguous words in the snippet of text in one of the search results comprises identifying the particular term that is highlighted on the user interface; and
wherein revising the search query based on the identified term comprises revising the search query based on the identified term that is highlighted on the user interface.

47. The method of claim 21, wherein executing the code comprises executing code configured to provide the modified context menu such that the modified context menu remains hidden until a user interacts with text in the search results, and such that the modified context menu is displayed overlaying the search results page in response to user interaction with text in the search results.

48. The method of claim 21, wherein executing the code comprises executing code configured to display the modified context menu adjacent the term that the user has selected within the string of contiguous words.

49. The method of claim 21, further comprising providing the second search results in a ranked order indicated by the search engine.

50. The method of claim 21, wherein providing the revised search query to the search engine comprises:
automatically providing the revised search query to the search engine without receiving further user input after user's selection of the control selected from the modified context menu.

51. The method of claim 21, wherein executing code that modifies the context menu comprises executing code that modifies the context menu to include a phrase search control that, when selected, causes the search query to be revised to require search results to include a phrase having terms in a specific order;
wherein the method comprises:
identifying a particular phrase of multiple terms that the user has selected within the string of contiguous words in the snippet of text of one of the search results; and
determining that the user selected the phrase search control after selecting the particular phase; and
wherein revising the search query comprises revising the search query to generate a revised query that includes the particular phrase and a phrase search operator that indicates that search results for the revised query should include the multiple terms of the particular phrase in a specific order that the multiple terms occur in the particular phrase.

52. The method of claim 21, wherein executing code that modifies the context menu comprises executing code that modifies the context menu to include a promote control that, when selected, causes the search query to increase a rank position of search results for the revised search query that have a particular term without requiring search results for the revised query to include the particular term;
wherein identifying the control selected from the modified context menu comprises determining that the user selected the promote control after the user selected the term from within the string of contiguous words in the snippet of text; and
wherein revising the search query comprises revising the search query to specify that, without requiring search results for the revised search query to include the term selected by the user, a rank position of search results that include the term selected by the user should be increased.

53. The method of claim 21, wherein executing code that modifies the context menu comprises executing code that modifies the context menu to include a demote control that, when selected, causes the search query to decrease a rank position of search results for the revised search query that have a particular term without requiring search results for the revised query to exclude the particular term;
wherein identifying the control selected from the modified context menu comprises determining that the user selected the demote control after the user selected the term from within the string of contiguous words in the snippet of text; and
wherein revising the search query comprises revising the search query to specify that, without requiring search results for the revised search query to exclude the term selected by the user, a rank position of search results that include the term selected by the user should be decreased.

54. The method of claim 21, further comprising:
in response to receiving the data indicating the user selection of the control for initiating a search query refinement, transmitting, to the search engine, data indicating that the user intends to initiate reformulation of the search query; and
receiving, from the search engine, the code that modifies the context menu associated with the search results page after transmitting, to the search engine, the data indicating that the user intends to initiate reformulation of the search query.

55. The method of claim 21, wherein revising the search query comprises adding one or more Boolean operators to the search query.
